(19) United States
(12) Patent Application Publication
(10) Pub. No.: US 2006/0216473 A1
(43) Pub. Date: Sep. 28, 2006

(54) Methods of manufacturing multilayer elastomeric laminates, and laminates

(76) Inventors: Robert Tomany, Fairfield, OH (US); Iyad Muslet, Mason, OH (US); Frank Eschenbacher, Schnelldorf (DE); Robert Mortellite, Maineville, OH (US); Katherine Edman, Mason, OH (US); Arrigo D. Jezzi, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/388,999

(22) Filed: Mar. 24, 2006

Related U.S. Application Data
(60) Provisional application No. 60/664,914, filed on Mar. 24, 2005.
(60) Provisional application No. 60/702,325, filed on Jul. 25, 2005.

(51) Int. Cl. B32B 3/10

(52) U.S. Cl. 428/137; 428/189; 428/190

(57) ABSTRACT

A method for forming a multilayer elastomeric laminate comprises laminating an elastomeric film onto a first substrate to form a laminate web having an elastomeric film surface, and slitting the laminate web to form laminate strips. At least one strip is then bonded on its elastomeric film surface to a second substrate having a width greater than the width of the laminate strip to form a multilayer elastomeric laminate. The multilayer elastomeric laminate may then be subjected to additional processing, including but not limited to activation, aperturing, and/or lamination to other materials.

### RELATED APPLICATION

In accordance with the provisions of 35 U.S.C. §119, Applicants claim priority of U.S. Provisional Patent Application No. 60/664,914 filed Mar. 24, 2005 and U.S. Provisional Patent Application No. 60/702,325 filed Jul. 25, 2005.

### FIELD OF THE INVENTION

The present invention relates to methods of manufacturing multilayered elastomeric laminates and relates to multilayer elastomeric laminates. In specific embodiments, the invention relates to such laminates in strip form and methods of manufacturing such laminates in strip form.

### BACKGROUND OF THE INVENTION

Elastomeric materials have long been prized for their ability to expand to fit over or around a larger object, and then retract to provide a snug fit around the object. This quality has been prized for centuries.

In recent years, synthetic polymeric elastomeric materials have supplemented or replaced natural rubber. Compounds such as polyurethane rubbers, styrene block copolymers, ethylene propylene rubbers, and other synthetic polymeric elastomers are well known in the art.

Elastomeric materials can take a variety of shapes. Elastomers can be formed as threads, cords, tapes, films, fabrics, and other diverse forms. The shape and structure of the elastomeric material is guided by the intended end use of the product. For instance, elastomers are often used in garments to provide a snug fit, such as in active wear. Elastomers can also form resilient but effective barriers, such as in the cuffs of thermal garments intended to retain body heat. In these applications, the elastomer is most often in the form of threads or filaments that are incorporated into the fabric of the garment.

One example of a type of garment where both fit and barrier properties are important is hygienic products such as diapers. Elastomeric materials are used in the waist, around the leg openings, in side panels, or in the fasteners, for example, in a diaper or in an underpants-type garment. The elastomeric materials in these regions improve the overall fit of the garment, and also make it much easier to both don and remove the garment. The elastomeric materials also act as resilient barriers, improving the containment capabilities of the garment while still allowing comfort and free movement to the wearer.

In a hygienic product, the elastomer can be in the form of threads, fabrics, or films. Using elastomeric threads can pose challenges in assembling the garment, since the threads must be applied as one component of many in the manufacturing process. These threads can also be weak and they tend to break, which could lead to the elastic failing even if there are redundant threads present. Elastomeric fabrics are somewhat easier to work with in a manufacturing process, but the fabrics themselves tend to be expensive both in raw materials and in the cost of manufacturing the fabric itself. Elastomeric films are typically easier to use in manufacturing than threads and are less expensive than elastomeric fabrics to produce. Elastomeric films also tend to be stronger than threads or fabrics, and less likely to fail in use.

However, a disadvantage of elastomeric films is that the polymers used to make the films are inherently sticky or tacky. This is particularly true of elastomeric polymers comprising styrene block copolymers, such as styrene-butadiene-styrene block copolymer. When elastomeric films made of these polymers are extruded and wound into a roll, the film will tend to stick to itself or “block,” thereby becoming difficult or impossible to unwind. A roll of film that has blocked cannot be unwound at normal manufacturing speeds without the film tearing or shredding, and in cases of extreme blocking, the film simply cannot be unwound at all. Blocking becomes more pronounced as the film is aged or stored in a warm environment, such as inside a storage warehouse or during transport.

Many attempts have been made to resolve the blocking problem of elastomeric films. Antiblocking agents, which are usually powdered inorganic materials such as silica or talc, can be incorporated within the film. However, antiblocking agents must be added in large quantities to reduce blocking to an acceptable level, and these high levels of antiblock are detrimental to the elastomeric properties of the film. Another means of reducing blocking is to roughen the surface of the film, such as by embossing the film, which reduces the surface-to-surface contact of the rolled film and introduces minute air pockets that help reduce the blocking. Unfortunately, this also tends to create thinner, weaker areas of the film, which are then subject to tearing and failure when the film is stretched. Another means of reducing blocking is to incorporate a physical barrier, such as a release liner, into the roll between the layers of wound film. The release liner is then removed when the roll of film is unwound for further processing. The release liner is usually discarded, though, creating waste and a significant extra expense for the manufacturer. Yet another means of reducing elastomeric film blocking is by coextruding very thin outer layers, also called ‘skins’ or ‘capping layers,’ of a nonblocking polymer onto the surface of the elastomeric film. Suitable nonblocking polymers for these skins include polyolefins such as polyethylene or polypropylene. This is relatively effective in preventing blocking, but when the elastomeric film is stretched (or ‘activated’) the skin layers, which are usually not elastomeric, will be stretched and deformed because the skin polymer cannot retract effectively. This creates a rough surface texture on the film which may be undesirable. Providing such skin layers also may also increase the complexity of the manufacturing process and the costs of the elastomeric film.

An extrusion laminate of elastomeric film and nonwoven fabric is taught in the co-assigned U.S. Pat. No. 5,477,172 (Wu '172), which is incorporated herein by reference. The presence of nonwoven fabric on one or both of the elastomeric film surfaces is effective in preventing roll blocking, and creates an elastomeric laminate with excellent stretch-and-recover properties.

However, in many applications, the elastomeric laminate must be attached to the body of another product. For instance, an elastomeric diaper tape tab must be attached to the chassis of the diaper on one side, and to a fastening device (adhesive tape or hook-type fastener) on the other side. At these attachment points, the diaper tape tab does not need elastomeric properties. Similarly, a wrist cuff on a garment does not need to be elastomeric at the point that the cuff is attached to the sleeve. Elastomeric polymers are expensive, and incorporating elastomeric materials in areas that do not need elastomeric properties is wasteful and an unnecessary expense to the manufacturer.

There remains a need for a means to effectively manufacture an elastomeric film that can be rolled and stored without blocking. Such a film should not have inferior elastomeric properties, should not create undue waste and manufacturing expense, and should present an appealing, pleasant surface texture after activation. An elastomeric film with these properties would clearly be superior to various conventional materials.

### SUMMARY OF THE INVENTION

In one embodiment, the present invention is directed to a method for forming a multilayer elastomeric laminate. The method comprises laminating an elastomeric film onto a first substrate to form a laminate web having an elastomeric film surface, then slitting the laminate web to form laminate strips. At least one laminate strip is bonded on the elastomeric film surface to a second substrate having a width greater than the width of the laminate strip to form a multilayer elastomeric laminate.

In another embodiment, the present invention is directed to a method for forming a multilayer elastomeric laminate. The method comprises laminating an elastomeric film onto a first substrate to form a laminate web having an elastomeric film surface, then slitting the laminate web to form laminate strips. A plurality of spaced-apart laminate strips are bonded on their elastomeric film surfaces to a second substrate having a width greater than the combined width of the laminate strips to form a plurality of multilayer elastomeric laminates. These spaced-apart multilayer elastomeric laminates may be slit apart into a plurality of laminates.

In yet another embodiment, the present invention is directed to a method for forming an elastomeric laminate. This method comprises providing strips of a laminate web comprising an elastomeric film bonded to a first substrate wherein the elastomeric film and the substrate are of substantially the same width and wherein the laminate strip has an elastomeric surface. One laminate strip or a plurality of laminate strips are bond on the elastomeric film surface to a second substrate having a width greater than the width of the laminate strip or the combined width of the plurality of laminate strips to form one or a plurality of multilayer elastomeric laminates. A plurality of spaced-apart multilayer elastomeric laminates may be slit apart into a plurality of laminates.

In yet another embodiment, the present invention is directed to a multilayer elastomeric laminate. This laminate comprises a strip of elastomeric film bonded on one film surface to a first substrate, where the strip of elastomeric film and first substrate are of substantially the same width. This strip of elastomeric film is bonded on the other film surface to a second substrate, wherein the second substrate has a greater width than the strip of elastomeric film.

Additional embodiments of the invention will be apparent in view of the following detailed description of the invention.

### BRIEF DESCRIPTION OF THE DRAWINGS

The invention will be more fully understood in view of the drawings, in which:

FIG. 1 is a schematic of one embodiment of a method according to the invention comprising an extrusion lamination method;

FIG. 2 is a schematic of another embodiment of a method according to the invention comprising an adhesive lamination method;

FIG. 3 is a schematic of an embodiment of a method according to the invention comprising a method of slitting and spacing apart laminate strips;

FIG. 4 is a schematic of another embodiment of a method according to the invention comprising an adhesive lamination method to form the multilayer elastomeric laminate;

FIGS. 5a and 5b schematically illustrate two examples of a multilayer elastomeric laminate material according to the invention; and

FIG. 6 is a schematic of another embodiment of a method according to the invention comprising a method of activating the multilayer elastomeric laminate.

### DETAILED DESCRIPTION OF THE INVENTION

The inventors have discovered that extruding or laminating the elastomeric film onto a non-elastomeric substrate material, such as spunbond, carded, or meltblown nonwoven fabrics or paper products such as tissue can eliminate roll blocking or reduce it to an acceptable level. Means of laminating substrates such as nonwoven materials to the elastomeric film are known and can be readily done in-line, requiring only the addition of an unwinder to supply the nonwoven material to the film extrusion line. The inventors have also demonstrated that the nonwoven material need not be removed from the film during later processing, and the nonwoven material will not interfere with the activation of the elastomeric film. The nonwoven material also gives the elastomeric film a pleasing, cloth-like surface that is most appealing when the film is used in skin-contact products such as garments or hygiene articles. Depending on the nature of the nonwoven material in the laminate, the strength properties (such as tear strength) of the elastomeric laminate may also be improved over the properties of the elastomeric film alone.

In one embodiment, the present invention is a novel method of manufacturing an elastomeric film laminate that resists roll blocking. The laminate manufactured by this process has comparable or improved elastomeric and strength properties compared to the unlaminated film, it is easy and inexpensive to manufacture, there is no excess waste, and the resulting product can be readily activated, converted, or otherwise incorporated into additional manufacturing steps.

For the purpose of this disclosure, the following terms are defined as follows:

“Film” refers to continuous or substantially continuous material in a sheet-like form where the dimensions of the material in the x (length) and y (width) directions are substantially larger than the dimension in the z (thickness) direction. Films have a z-direction thickness in the range of about 1 μm to about 1 mm.

“Elastomeric” or “elastomer” refer to polymer materials which can be stretched to at least about 150% of their original dimension, and which then retract to no more than 120% of their original dimension, in the direction of the applied stretching force. For example, an elastomeric film that is 10 cm long should stretch to at least about 15 cm under a stretching force, and then retract to no more than about 12 cm when the stretching force is removed.

“Laminate” as a noun refers to a layered structure of sheet-like materials stacked and bonded so that the layers are substantially coextensive across the width of the narrowest sheet of material. The layers may comprise films, fabrics, or other materials in sheet form, or combinations thereof. For instance, a laminate may be a structure comprising a layer of film and a layer of fabric bonded together across their width such that the two layers remain bonded as a single sheet under normal use. A laminate may also be called a composite or a coated material. “Laminate” as a verb refers to the process by which such a layered structure is formed.

“Activation” or “activating” refers to a process by which the elastomeric film or laminate is rendered easy to stretch. Most often, activation is a physical modification or deformation of the elastomeric film. Stretching a film for the first time is one means of activating the film. An elastomeric material that has undergone activation is called “activated.” A common example of activation is blowing up a balloon. The first time the balloon is blown up (“activated”), the material in the balloon is stretched. If the material in the balloon is difficult to stretch, the person inflating the balloon will often manually stretch the uninflated balloon to make the inflation easier. If the inflated balloon is allowed to deflate and then blown up again, the “activated” balloon is much easier to inflate.

“Slitting” refers to a process of cutting a web, such as a film, fabric, composite, or laminate into strips. Slitting may be done by any known means, including knives, heated blades, crush-cut wheels, sheer-slitting wheels, water jets, and lasers.

“Spaced apart” refers to a plurality (2 or more) of strips of web-like materials that are placed in a configuration where the strips are substantially parallel to one another leaving a gap or space between the edges of adjacent strips. This gap or space should be wide enough that the strips do not touch or overlap one another. For the purpose of this invention, the gap or space between spaced-apart strips may be any appropriate distance, and, in one non-limiting embodiment, is from about 1 mm to about 3 m wide.

The elastomeric film of the invention comprises any extrudable elastomeric polymer. Examples of such elastomeric polymers include block copolymers of vinyl arylene and conjugated diene monomers, natural rubbers, polyurethane rubbers, polyester rubbers, elastomeric polyolefins, elastomeric polyamides, or the like. The elastomeric film may also comprise a blend of two or more elastomeric polymers of the types previously described. Preferred elastomeric polymers are the block copolymers of vinyl arylene and conjugated diene monomers, such as AB, ABA, ABC, or ABCA block copolymers where the A segments comprise arylenes such as polystyrene and the B segments comprise dienes such as butadiene, isoprene, or ethylene butadiene. These block copolymers are readily available from polymer manufacturers under tradenames such as KRATON® or Dexco™.

The elastomeric film may include other components to modify the film properties, aid in the processing of the film, or modify the appearance of the film. For example, polymers such as polystyrene homopolymer may be blended with the elastomeric polymer in the film in order to stiffen the film and improve the strength properties of the film. In one embodiment, a polystyrene homopolymer is included in the elastomeric film in an amount of from about 10% to about 35%, by weight of the film. Viscosity-reducing polymers and plasticizers may be added as processing aids. Other additives such as pigments, dyes, antioxidants, antistatic agents, antiblock aids, slip agents, foaming agents, heat and/or light stabilizers, and inorganic and/or organic fillers may be added to the elastomeric film in conventional amounts as desired. In addition, the surface of the elastomeric film may optionally be treated prior to lamination. Such surface treatments could be, for example: dusting the surface with powder; coating the surface with a liquid, slurry, extrusion or other such coating; energy treatment of the surface, such as corona, flame, or plasma treatment; and/or other known surface treatments.

The elastomeric film employed in the methods and laminates of this invention may comprise a single layer of film comprising an elastomeric polymer. The inventive elastomeric film may also comprise a multilayer film. Each layer of a multilayer elastomeric film may comprise elastomeric polymers, or the layers may comprise either elastomeric or thermoplastic non-elastomeric polymers, either singly or in combination, in each layer. The only limitations are that at least one layer of the multilayer elastomeric film must comprise an elastomeric polymer and the multilayer elastomeric film as a whole must be an elastomeric film. If the elastomeric film is multilayer and one or more layers comprise a non-elastomeric polymer, it is preferred that the non-elastomeric polymer comprises an extensible polymer.

Any film-forming process can be employed to prepare the elastomeric film. In a specific embodiment, an extrusion process, such as cast extrusion or blown-film extrusion is used to form the film. Such processes are well known. The elastomeric film may also be in the form of a multilayer film. Coextrusion of multilayer films by cast or blown processes are also well known. Other film forming processes may also be employed as desired.

The elastomeric film is laminated to a first substrate to form a laminate web. In one non-limiting embodiment, the first substrate is a nonwoven fibrous web. A number of definitions have been proposed for nonwoven fibrous webs. The fibers are usually staple fibers or continuous filaments. As used herein “nonwoven fibrous web,” “nonwoven fabric,” “nonwoven material” or “nonwoven” are used in the generic sense to define a generally planar structure that is relatively flat, flexible and porous, and is composed of staple fibers or continuous filaments. Typically, such nonwoven materials are formed by spunbonded, carded, wet laid, air laid or melt blown processes. Suitable nonwovens may comprise, but are not limited to, monocomponent, bicomponent, or multicomponent fibers of polyethylene, polypropylene, polyesters, rayon, cellulose, nylon, and blends of such fibers. Nonwoven materials comprising fibers of elastomeric materials, such as polyurethanes, polyisoprenes, polystyrene block copolymers, and blend thereof, are also suitable for the present invention. Paper products, such as tissue or tissue-like products comprising cellulose-based or cellulosic fibers formed into a mat, are considered nonwoven fibrous webs or nonwoven materials that fall within the scope of this invention. The nonwoven materials may comprise fibers that are homogenous structures or comprise bicomponent structures such as sheath/core, side-by-side, islands-in-the-sea, and other known bicomponent configurations. For a detailed description of nonwovens, see “Nonwoven Fabric Primer and Reference Sampler” by E. A. Vaughn, Association of the Nonwoven Fabrics Industry, 3d Edition (1992). Such nonwoven fibrous webs typically have a weight of about 5 grams per square meter (gsm) to 75 gsm. For the purpose of the present invention, the nonwoven may be very light, with a basis weight of about 5 to 20 gsm or any other basis weight which is adequate to prevent roll blocking when laminated to the desired elastomeric film. However, a heavier nonwoven, with a basis weight of about 20 to 75 gsm, may be desired in order to achieve certain properties, such as a pleasant cloth-like texture, in the resulting laminate or end-use product.

Also, within the scope of this invention are other types of substrate layers, such as woven fabrics, knitted fabrics, scrims, netting, etc. These materials may certainly be used as the protective layer that prevents the elastomeric film layer from roll blocking. However, because of cost, availability, and ease of processing, nonwoven fabrics are usually preferred for the laminates in the inventive process.

In addition, any process that deposits fibers onto the surface of the elastomeric film so that the fibers adhere to the elastomeric film and form a fibrous or cloth-like surface would be considered a process that forms a nonwoven material that falls within the scope of this invention. One example of such a fiber deposition process is flocking. Another example of such a fiber deposition process is manufacturing spunbond or meltblown fibers in situ and depositing these fibers directly onto the film.

The elastomeric film and the first substrate, comprising, for example, a nonwoven material, are laminated by any known means, such as extrusion lamination, adhesive lamination, thermal lamination, ultrasonic lamination or other lamination techniques known in the art.

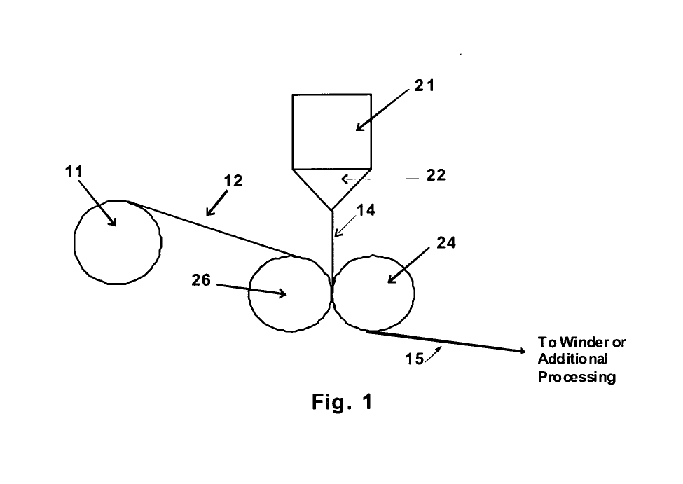

One embodiment of the lamination method is extrusion lamination, illustrated in FIG. 1. An elastomeric film 14 is melt-extruded from an extruder 21 through a film-forming die 22 and drops to the nip between the illustrated metal roll 24 and rubber roll 26. The metal roll may be chilled to rapidly cool the molten polymer film. The metal roll 24 may also be engraved with an embossing pattern if such a pattern is desired on the resulting film. A nonwoven material 12 is unwound from roll 11 and introduced into the nip between the metal and rubber rolls as well. The film 14 and nonwoven 12 are pressed together at the nip at a nip pressure adequate to form a satisfactory bond between the layers. A nip pressure of about 0 to 100 pounds per linear inch is usually appropriate for forming a satisfactory bond.

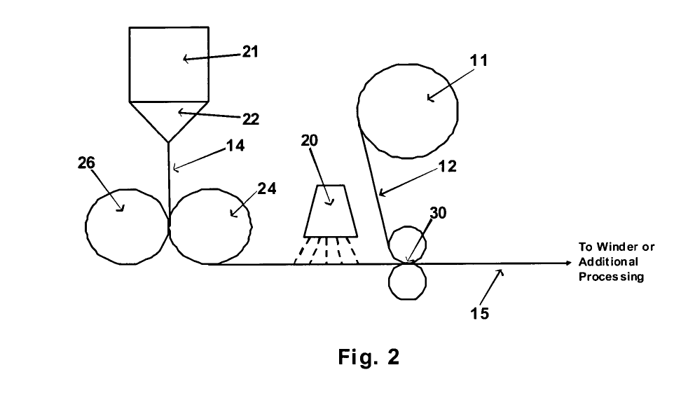

Another embodiment of a lamination method is adhesive lamination, illustrated in FIG. 2. An elastomeric film 14 is melt-extruded from an extruder 21 through a film-forming die 22 and drops to the nip between the illustrated metal roll 24 and rubber roll 26. The metal roll 24 may be chilled to rapidly cool the molten polymer film. The metal roll may also be engraved with an embossing pattern if such a pattern is desired on the resulting film. After the cast film has cooled and solidified, it passes to an adhesive bonding station, where adhesive is applied, such as with a spray unit 20 onto the film. Alternatively, the spray unit 20 may spray adhesive onto the incoming nonwoven material 12. The nonwoven material 12 from roll 11 is introduced into a nip 30 that presses the film 14 and nonwoven 12 together at a nip pressure adequate to form a satisfactory bond between the layers. A nip pressure of about 0 to 100 pounds per linear inch is usually appropriate for forming a satisfactory adhesive bond.

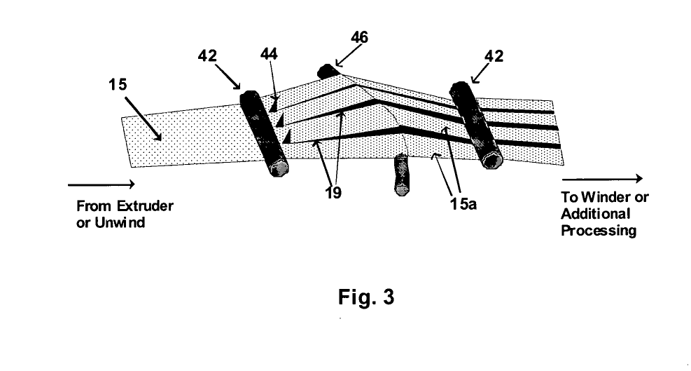

Once the laminate web of elastomeric film and the first substrate is formed, the laminate web 15 is slit into strips. One embodiment of the slitting process is illustrated in FIG. 3. The laminate web 15 is stabilized, for instance, by being run over an idler roll 42, prior to slitting. The web is then slit by an appropriate slitting device. In one nonlimiting embodiment, illustrated in FIG. 3, slitter knives 44 are used to slit the laminate web. These knives 44 are placed such that the laminate web is slit to strips of the desired width. The laminate web may also be slit by other slitting devices, such as heated blades, crush-cut wheels, sheer-slitting wheels, water jets, or lasers.

After being slit, the laminate strips may be spaced apart by an appropriate spreading or separating device. In one nonlimiting embodiment, illustrated in FIG. 3, the strips are spaced apart by being run over a bowed roll 46, which is a known device for spreading sheet-like materials. The bowed roll 46 causes the laminate strips to be separated by gaps 19 between each adjacent laminate strip 15a. The laminate strips 15a are stabilized, for example by idler rolls 42 and guided to the next processing step. Other spreading or separating devices may also be used to space the laminate strips. One such separating device is taught in the co-assigned U.S. Pat. No. 6,092,761, which is incorporated herein by reference.

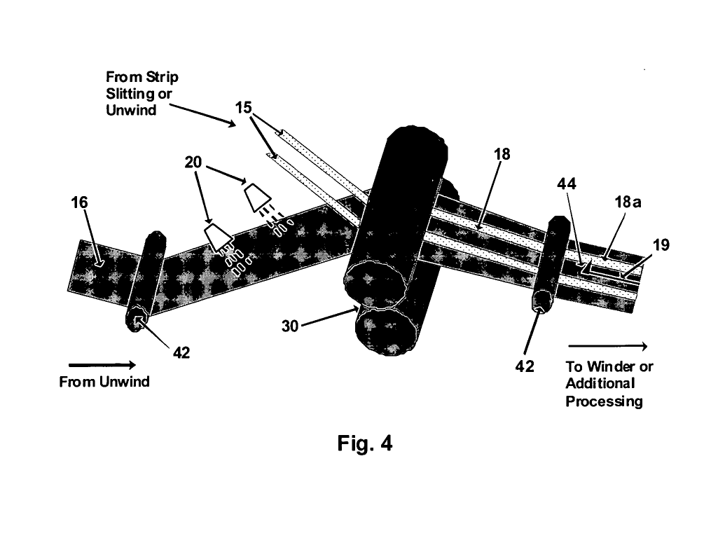

The laminate strips now comprise an elastomeric film and a first substrate, with an elastomeric film surface and a substrate surface on opposite sides of each laminate strip. The laminate strips are bonded to a second substrate on the elastomeric film surface of the laminate strips to form the multilayer elastomeric laminate. In one nonlimiting embodiment, illustrated in FIG. 4, a second substrate 16 is introduced. The width of the second substrate 16 is greater than the combined width of the laminate strips 15 to be bonded to the second substrate. Adhesive is applied to the second substrate 16 with adhesive spraying units 20. The adhesive may be applied to the entire width of the substrate 16 or it may be applied in stripes or zones that correspond to the future placement of the elastomeric strips. For this embodiment, two laminate strips 15 are introduced and placed on the second substrate. The laminate strips and second substrate pass through a nip 30 that presses the strips 15 and substrate 16 into a multilayer elastomeric laminate 18. The nip pressure is maintained at about 0 to 100 pounds per linear inch in order to form an adequate bond between the layers.

One skilled in the art will recognize that a single elastomeric strip 15 or a plurality of elastomeric strips 15 may be bonded to the second substrate 16 in order to form the multilayer elastomeric laminate. One skilled in the art will also recognize that the elastomeric strips 15 and the second substrate 16 may be bonded by other means, such as thermal bonding, ultrasonic bonding, and other techniques known in the art.

If a plurality of elastomeric strips 15 are bonded to the second substrate 16, the resulting multilayer elastomeric laminate 18 may be slit into a plurality of strips of multilayer elastomeric laminates 18a. FIG. 4 illustrates one nonlimiting embodiment of the slitting step. A slitter knife 44 slits the multilayer elastomeric laminate 18 through an area of the laminate that comprises only the second substrate 16.

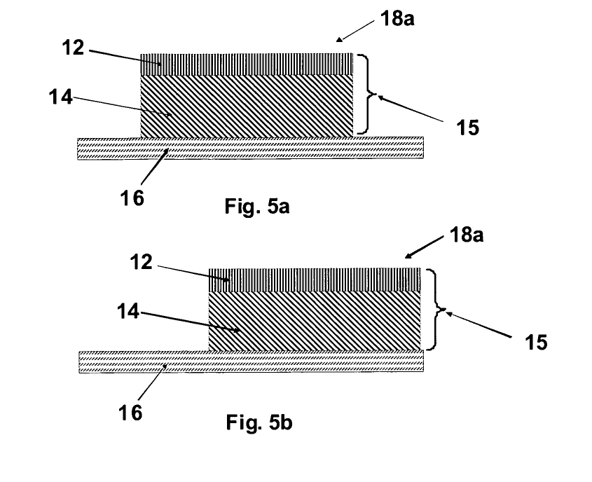

The strips may be slit along a line somewhere in the middle area of substrate 16 so that the resulting multilayer elastomeric laminate strip has the second substrate 16 extending beyond the elastomeric strip 15 on both sides of the strip 15. After slitting, two strips of multilayer elastomeric laminate 18a separated by gap 19 result. FIG. 5a illustrates a cross-section of one nonlimiting embodiment of the resulting multilayer elastomeric laminate strip. An elastomeric laminate strip 15 (comprising elastomeric film 14 and first substrate 12) is bonded to a wider strip of second substrate 16 to form the multilayer elastomeric laminate 18a. The second substrate 16 extends beyond both sides of the laminate strip 15.

In another embodiment, the multilayer elastomeric laminate 18 may be slit through an area of the laminate that comprises only the second substrate 16 near or substantially next to an edge of the laminate strip 15. The resulting multilayer elastomeric laminate strip has the second substrate 16 extending beyond the laminate strip 15 on one side of the strip 15, with little or substantially none of substrate 16 extending beyond the other side of laminate strip 15. FIG. 5b illustrates a cross-section of a nonlimiting embodiment of the resulting multilayer elastomeric laminate strip. An elastomeric laminate strip 15 (comprising elastomeric film 14 and first substrate 12) is bonded to a wider strip of second substrate 16 to form the multilayer elastomeric laminate 18a. The second substrate 16 extends beyond one side of the laminate strip 15, with substantially none of substrate 16 extending beyond the other side of laminate strip 15.

The multilayer elastomeric laminate 18 may be activated to render the multilayer elastomeric laminate easy to stretch. The multilayer elastomeric laminate of the present invention is particularly suited to activation by incremental stretching. As disclosed in the commonly-assigned patent Wu '172, elastomeric laminates of the sort made here can be activated by incremental stretching using the incremental stretching rollers described therein.

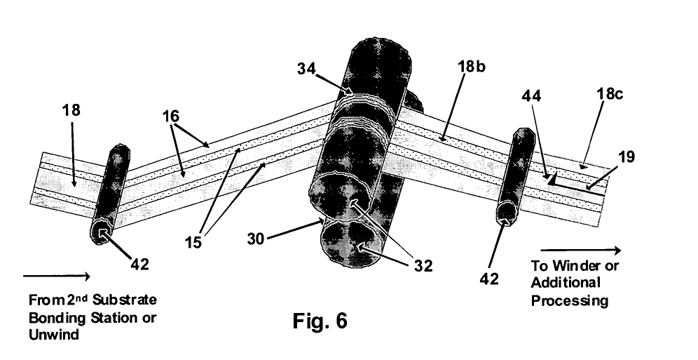

One embodiment of the activation process is illustrated in FIG. 6. The multilayer elastomeric laminate 18, comprising one or more elastomeric laminate strips 15 and second substrate 16, is introduced to the activation station. The multilayer elastomeric laminate 18 passes through the nip 30 between two grooved intermeshing rolls 32. The design of the intermeshing rolls is described fully in the Wu '172 patent. For the purposes of the present invention, the intermeshing rolls may have intermeshing grooves 34 in zones, as illustrated in FIG. 6. In this embodiment, the intermeshing grooves 34 correspond to the areas of laminate 18 that comprise the elastomeric laminate strip 15. Hence, in this embodiment, only the elastomeric zone of laminate 18 is incrementally stretched and activated. However, in another embodiment, the intermeshing grooves 34 may be located in zones corresponding to other areas of the laminate 18, or the intermeshing grooves 34 may be located across the full width of the intermeshing rolls 32. After intermeshing, the laminate 18 becomes an activated multilayer elastomeric laminate 18b.

If the multilayer elastomeric laminate 18 has a plurality of elastomeric laminate strips, as shown in FIG. 6, the activated laminate 18b may be slit into a plurality of strips of multilayer elastomeric laminates 18c. FIG. 6 illustrates one nonlimiting embodiment of the slitting step. A slitter knife 44 slits the activated multilayer elastomeric laminate 18b through an area of the laminate that comprises only the second substrate 16. As described above and illustrated in FIG. 5a, the activated laminate strips may be slit to make multilayer elastomeric laminate strips with the second substrate 16 extending beyond the elastomeric strip 15 on both sides of the strip 15. Alternatively, as illustrated in FIG. 5b, the activated laminate strips may be slit to make multilayer elastomeric laminate strips with the second substrate 16 extending beyond one side of the laminate strip 15, with substantially none of substrate 16 extending beyond the other side of laminate strip 15.

The multilayer elastomeric laminates, whether unactivated (18 or 18a) or activated (18b or 18c) may be wound onto a roll or festooned into a container and stored for later use. Alternatively, the laminates 18, 18a, 18b or 18c may undergo additional processing steps, such as aperturing, printing, adhesive lamination to other materials, additional slitting, or other such processing steps.

The multilayer elastomeric laminates 18, 18a, 18b or 18c may be incorporated into a number of articles where stretch-and-recover properties are useful. Examples of such articles include clothing components, waistbands, leg cuffs, wrist cuffs, ankle cuffs, tape tabs, attachment ears on a hygienic device, stretch panels, and bandages.

One skilled in the art will recognize that the manufacturing steps described in the embodiments above may be performed sequentially, continually, or in any reasonable combination thereof. The steps may also be performed in sequences that differ from those presented in the embodiments described above. Additional embodiments within the scope of the invention will be apparent to those of ordinary skill in the art and are encompassed by the following claims. The preceding description and specific and/or exemplary embodiments therein are presented to illustrate diverse aspects of the present invention, and are not intended to limit the invention in any way.

What is claimed is:

1. A method for forming a multilayer elastomeric laminate, comprising:
a) laminating an elastomeric film onto a first substrate to form a laminate web having an elastomeric film surface;
b) slitting the laminate web to form laminate strips; and
c) bonding the elastomeric film surface of at least one laminate strip to a second substrate having a width greater than the width of the laminate strip to form a multilayer elastomeric laminate.

2. The method of claim 1 wherein the multilayer elastomeric laminate is activated to render the multilayer elastomeric laminate stretchable and recoverable.

3. The method of claim 2 wherein the multilayer elastomeric laminate is activated by incremental stretching.

4. The method of claim 1 wherein the elastomeric film comprises an elastomeric polymer selected from the group consisting of block copolymers of vinyl arylene and conjugated diene monomers, natural rubbers, polyurethane rubbers, polyester rubbers, elastomeric polyolefins, elastomeric polyamides, and blends thereof.

5. The method of claim 4 wherein the elastomeric film comprises a blend of elastomeric polymers and high-impact polystyrene.

6. The method of claim 1 wherein the elastomeric film comprises a multilayer elastomeric film.

7. The method of claim 1 wherein the first substrate comprises a polymer film, nonwoven fabric, paper product, woven fabric, knitted fabric, scrim, netting, or combination thereof.

8. The method of claim 1 wherein the laminating step comprises depositing the first substrate comprising loose fibers on the elastomeric film.

9. The method of claim 1 wherein the second substrate comprises a polymer film, nonwoven fabric, paper product, woven fabric, knitted fabric, scrim, netting, or combination thereof.

10. The method of claim 1, further comprising aperturing the multilayer elastomeric laminate.

11. The method of claim 1, further comprising winding the multilayer elastomeric laminate into a roll.

12. The method of claim 1, further comprising festooning the multilayer elastomeric laminate into a holding container.

13. A method for forming a multilayer elastomeric laminate, comprising:
a) laminating an elastomeric film onto a first substrate to form a laminate web having an elastomeric film surface;
b) slitting the laminate web to form laminate strips; and
c) bonding the elastomeric film surfaces of a plurality of spaced-apart laminate strips to a second substrate having a width greater than the combined width of the laminate strips to form a plurality of multilayer elastomeric laminates.

14. The method of claim 13 wherein the plurality of laminate strips are spaced apart by a spreading device prior to the bonding step.

15. The method of claim 13 wherein the second substrate is slit between adjacent spaced apart laminate strips to form a plurality of multilayer elastomeric laminate strips.

16. The method of claim 15 wherein the second substrate is slit to form a multilayer elastomeric laminate strip wherein the second substrate extends beyond the elastomeric film and the first substrate on one side of the multilayer elastomeric laminate strip.

17. The method of claim 15 wherein the second substrate is slit to form a multilayer elastomeric laminate strip wherein the second substrate extends beyond the elastomeric film and the first substrate on both sides of the multilayer elastomeric laminate strip.

18. The method of claim 13 wherein the plurality of multilayer elastomeric laminates are activated to render the multilayer elastomeric laminates stretchable and recoverable.

19. The method of claim 13 wherein the plurality of multilayer elastomeric laminates are activated by incremental stretching.

20. The method of claim 13 wherein the elastomeric film comprises an elastomeric polymer selected from the group consisting of block copolymers of vinyl arylene and conjugated diene monomers, natural rubbers, polyurethane rubbers, polyester rubbers, elastomeric polyolefins, elastomeric polyamides, and blends thereof.

21. The method of claim 20 wherein the elastomeric film comprises a blend of elastomeric polymers and high-impact polystyrene.

22. The method of 13 wherein the first substrate comprises a polymer film, nonwoven fabric, paper product, woven fabric, knitted fabric, scrim, netting, or combination thereof.

23. The method of claim 13 wherein the laminating step comprises depositing the first substrate comprising loose fibers on the elastomeric film.

24. The method of claim 13 wherein the second substrate comprises a polymer film, nonwoven fabric, paper product, woven fabric, knitted fabric, scrim, netting, or combination thereof.

25. The method of claim 13, further comprising aperturing the multilayer elastomeric laminate.

26. The method of claim 13, further comprising winding the multilayer elastomeric laminate into a roll.

27. The method of claim 13, further comprising festooning the multilayer elastomeric laminate into a holding container.

28. A method for forming an elastomeric laminate, comprising:
a) providing strips of a laminate web comprising an elastomeric film bonded to a first substrate wherein the elastomeric film and the substrate are of substantially the same width and wherein the laminate strip has an elastomeric surface; and
b) bonding the elastomeric film surface of a laminate strip or the elastomeric film surfaces of a plurality of laminate strips to a second substrate having a width greater than the width of the laminate strip or the combined width of the plurality of laminate strips to form one or a plurality of multilayer elastomeric laminates, respectively.

29. The method of claim 28 wherein the plurality of laminate strips are spaced apart by a spreading device prior to the bonding step.

30. The method of claim 28 wherein the second substrate is slit between adjacent spaced apart laminate strips to form a plurality of multilayer elastomeric laminate strips.

31. The method of claim 30 wherein the second substrate is slit to form a multilayer elastomeric laminate strip wherein the second substrate extends beyond the elastomeric film and the first substrate on one side of the multilayer elastomeric laminate strip.

32. The method of claim 30 wherein the second substrate is slit to form a multilayer elastomeric laminate strip wherein the second substrate extends beyond the elastomeric film and the first substrate on both sides of the multilayer elastomeric laminate strip.

33. The method of claim 30 wherein each multilayer elastomeric laminate is activated to render the multilayer elastomeric laminate stretchable and recoverable.

34. The method of claim 30 wherein each multilayer elastomeric laminate is activated by incremental stretching.

35. The method of claim 30 wherein the elastomeric film comprises an elastomeric polymer selected from the group consisting of block copolymers of vinyl arylene and conjugated diene monomers, natural rubbers, polyurethane rubbers, polyester rubbers, elastomeric polyolefins, elastomeric polyamides, and blends of these polymers.

36. The method of claim 35 wherein the elastomeric film comprises a blend of elastomeric polymers and high-impact polystyrene.

37. The method of claim 30, further comprising aperturing the multilayer elastomeric laminate.

38. The method of claim 30, further comprising winding the multilayer elastomeric laminate into a roll.

39. The method of claim 30, further comprising festooning the multilayer elastomeric laminate into a holding container.

40. A multilayer elastomeric laminate, comprising a strip of elastomeric film bonded on one film surface to a first substrate, wherein the strip of elastomeric film and first substrate are of substantially the same width, and wherein the strip of elastomeric film is bonded on the other film surface to a second substrate, wherein the second substrate has a greater width than the strip of elastomeric film.

41. The laminate of claim 40 wherein the multilayer elastomeric laminate is stretchable and recoverable.

42. The laminate of claim 40 wherein the multilayer elastomeric laminate is incrementally stretched.

43. The laminate of claim 40 wherein the elastomeric film comprises an elastomeric polymer selected from the group consisting of block copolymers of vinyl arylene and conjugated diene monomers, natural rubbers, polyurethane rubbers, polyester rubbers, elastomeric polyolefins, elastomeric polyamides, and blends of these polymers.

44. The laminate of claim 43 wherein the elastomeric film comprises a blend of elastomeric polymers and high-impact polystyrene.

45. The method of claim 40, further comprising aperturing the multilayer elastomeric laminate.

46. The method of claim 40, further comprising winding the multilayer elastomeric laminate into a roll.

47. The method of claim 40, further comprising festooning the multilayer elastomeric laminate into a holding container.

48. An article comprising the laminate of claim 40, in the form of a clothing component, a waistband, a leg cuff, a wrist cuff, an ankle cuff, a tape tab, an ear on a hygiene device, a stretch panel, or a bandage.
